(19) United States
(12) Patent Application Publication
(10) Pub. No.: US 2011/0132954 A1
(43) Pub. Date: Jun. 9, 2011

(54) SCRIBING WHEEL AND METHOD FOR SCRIBING BRITTLE MATERIAL SUBSTRATE

(76) Inventors: Maoko Tomei, Osaka (JP); Keitaro Okamoto, Hyaso (JP); Hiroshi Tomimori, Osaka (JP)

(21) Appl. No.: 12/996,199

(22) PCT Filed: Jun. 3, 2009
(86) PCT No.: PCT/JP2009/060130

§ 371 Date: Feb. 24, 2011

(30) Foreign Application Priority Data
Jun. 5, 2008 (JP) 2008-147613

(51) Int. Cl. B28D 5/00; B26D 3/08; B26F 3/00

(52) U.S. Cl. 225/2; 83/886; 83/880

(57) ABSTRACT

A scribing wheel having a long life with little wear at the blade even when used to scribe a substrate that is relatively hard, such as a ceramic substrate, which can create deep vertical cracks if necessary is provided. A number of grooves 13 are created with predetermined intervals at the blade 12 that is along the ridgeline of the wheel of which the outer diameter is within a range of 1 mm to 5 mm. The depth D of these grooves 13 is 25 μm or more and the length of the ridgeline 14 between grooves is 25 μm or more. It is preferable for the pitch P of the grooves 13 to be in a range from 50 μm to 200 μm.

### TECHNICAL FIELD

The present invention relates to a scribing wheel which is appropriate for use for creating a scribe line on the surface of a brittle material substrate and a method for scribing a line on the surface of a brittle material substrate, and in particular to a scribing wheel which is appropriate for use for creating a scribe line on the surface of a brittle material that is harder than glass, for example a ceramic substrate (a substrate to be built in an electronic part, such as a multilayer substrate made of ceramic burned at a high temperature (HTCC substrate) and a multilayer substrate made of ceramic burned at a low temperature (LTCC substrate)), sapphire or silicon, as well as a scribing method.

### BACKGROUND ART

In recent years LTCC substrates have been drawing attention as a means for making it possible to increase the density and reduce the size of a module, and in particular it is said that LTCC substrates are optimal for high frequency modules for communication instruments. Further increase in the productivity and further reduction in cost have been in demand by improving the cutting process during the manufacture of the LTCC substrates.

In accordance with a method for cutting a ceramic substrate, such as an LTCC substrate, grooves in V shape are created in a green sheet before burning and the green sheet is broken into pieces along the grooves after burning.

In the case of LTCC substrates, the green sheet shrinks after burning by 10% or more in the length. In addition, the rate of shrinkage is inconsistent throughout the green sheet. Since grooves in V shape are created and the lines for cutting are set before burning, inconsistency in the rate of shrinkage causes inconsistency in the size of the pieces gained through cutting after burning, which results in a lower yield. In addition, burning after the creation of grooves makes is easier for the substrate to be deformed during burning, and the cut surfaces become poor. Furthermore, in the case where the substrate is thin, the green sheet with grooves before burning and the burned substrate before cutting may break unexpectedly along the grooves in V shape when transported, and thus there may be a risk of problems hindering transportation. In order to prevent the green sheet from warping during burning, the grooves in V shape may be created both on the top and bottom of the green sheet. In this method, however, it is difficult to position the grooves.

Dicing, which is widely used to cut semiconductor wafers, is also possible as a method for cutting a ceramic substrate, such as an LTCC substrate. However, dicing has the following problems: (1) the rate of cutting is generally as slow as 5 to 10 min/sec, making the tact time long and the productivity extremely low. (2) Loss of material cannot be avoided due to the thickness of the dicing saw (kerf loss). (3) The cut surfaces easily chip. (4) It is necessary to use cooling and washing water, and therefore MQL (minimum quantity lubrication) is impossible though desirable since it is environmentally friendly, and substrates on which electronic parts are mounted cannot be diced. (5) Extra steps of pasting and removing the substrate from a dicing table are required. (6) The quality of the cut surface is greatly affected by the diamond abrasive grains. (7) The life of the blade is short, making the running cost high. In particular, a large capital investment becomes necessary in order to increase the productivity, because of the low rate of cutting, and thus the demand for developing a cutting method according to which the rate of cutting is high and the cost is lower than for dicing has been increasing.

Though laser scribing is also possible, it has the following problems: (1) Marks remain on the cut surfaces as a result of perforation through pulse irradiation, which makes the quality lower. (2) The process causes fumes due to the heat. (3) The dielectric properties lower due to the heat processing. (4) The cost of the apparatus is high.

Therefore, ceramic substrates may be cut in accordance with a method that is widely used to cut glass substrates. That is to say, a scribing wheel may be rolled over a substrate with pressure applied so that a scribe line is created on the surface of the substrate, which causes vertical cracking from the surface of the substrate (scribing step), and then pressure is applied to the substrate, so that the vertical cracks deepen to the rear of the substrate, and thus the substrate is cut (breaking step). Cutting through breaking is preferable over cutting through sawing using a diamond cutting saw (or wheel) or a diamond dicing saw because no glass chips are created.

However, ceramic substrates are generally harder than glass substrates, and therefore cutting of a ceramic substrate through breaking has the following problems: (1) It is difficult for the scribing wheel to bite into ceramic substrates, and thus it is difficult to create a scribe line. (2) Cracks created through scribing barely extend in the direction of the thickness of the substrate, and thus it is difficult for the cracks to run deep, making it difficult to break the substrate. (3) When there are through holes in the ceramic substrate, it is difficult for the wheel to roll straight, and thus scribe lines are not created in predetermined locations, the amount of bite of the scribing wheel becomes inconsistent, and the life of the scribing wheel becomes shorter.

Cutting through breaking has been used for a long time as a method for cutting sapphire and silicon, but use of a cutting saw (or wheel) or a dicing saw containing a fine diamond powder is preferable in order to cut sapphire or silicon with a higher yield.

It is important in the cutting of a glass substrate through breaking to prevent horizontal cracking and chipping when scribing the substrate. In order to make it easy to break a glass substrate, vertical cracks should extend deep in the direction of the thickness of the glass substrate. However, the depth of the vertical cracks that can be created in non-alkali glass for liquid crystal displays, for example, through scribing without causing horizontal cracks or chipping is only approximately 13% of the thickness of the glass substrate, and thus a breaking step is indispensable (Non-Patent Document 1). In addition, in order to cut a ceramic substrate for electronic parts through breaking with a high yield, multi-pass scribing is necessary, because vertical cracks created through scribing using a conventional scribing wheel are too shallow.

The present applicant has proposed various types of scribing wheels for use for scribing a glass substrate. One example is a scribing wheel 1′ where a number of grooves 13 are created at predetermined intervals at the blade (peripheral ridge) 12 that is the ridgeline of the circumference 11 of the wheel in disc form in FIG. 8 (see for example Patent Document 1). As mother glass substrates for flat panel displays (hereinafter referred to as FPD's), such as liquid crystal panels, become larger, it becomes more difficult to turn over a large pasted mother glass substrate in order to break it, and it is necessary to increase the yield in the breaking process, and thus development of a technique for cutting a substrate without breaking it has been required. Thus, the present applicant has developed a “breakless scribing wheel” that changes the conventional concept of cutting a glass substrate. Patent Document 1 discloses a scribing wheel for glass (deep biting type) where grooves of a predetermined depth are created along the ridge with a predetermined pitch so that vertical cracks run deeper than those created according to the prior art, which makes the breaking process easier, or vertical cracks are as deep as 80% or more of the thickness of the glass substrate, which makes the breaking process unnecessary.

In addition, the applicant has proposed a scribing wheel for dividing pasted glass substrates together, a scribing wheel for scribing a glass mother substrate for FPD's without causing slipping despite the hardness of the glass (Patent Document 2) and a scribing wheel for making the cracks diagonal relative to the surface of the glass so that a circular or other, irregular shape can be easily removed from the substrate (Patent Document 3).

The scribing wheel of a deeper biting type in Patent Document 1 easily bites into glass substrates and fragile materials that are harder than glass (such as ceramic), and can create vertical cracks that run deep in the direction of the thickness of the substrate. However, when a scribing wheel of a deeper biting type for glass substrates is used to cut a hard, fragile material, the blade 12 wears in a short period of time, and thus such use is not practical. In addition, the scribing wheel in Patent Document 2 can scribe a substrate without slipping to a certain extent, but cannot make vertical cracks run deep in the direction of the thickness of the substrate. The scribing wheel in Patent Document 3 is also not sufficient in the depth of the vertical cracks and the life of the blade.

Non-Patent Document 1: Nagaoka University of Technology, Toshihiko Ono, Doctorate Thesis: “Study For Cutting in accordance with Method for Scribing and Breaking Liquid Crystal Glass,” 2000.

### Patent Document 1: Japanese Unexamined Patent Publication H9 (1997)-188534

### Patent Document 2: WO 2007/004700

### Patent Document 3: Japanese Unexamined Patent Publication 2000-219527

### DISCLOSURE OF THE INVENTION

### Problem to be Solved by the Invention

The life of scribing wheels is determined mainly by the degree of wear of the blade along the ridgeline. When the blade is worn and round, vertical cracks are not sufficient when a substrate is scribed, and therefore increase in the resistance to wear of scribing wheels has been strongly in demand.

Furthermore, ceramic substrates, which are relatively hard among brittle material substrates, are wet cut using a dicing saw or the like, and it is inevitable to treat chips and grinding fluid according to the prior art. The possibility of use of a scribing wheel which can dry cut a substrate without additional treatment has started being examined. When a relatively hard brittle material, such as a ceramic substrate, is scribed using a conventional scribing wheel, the blade wears immediately, and the life of the scribing wheel is very short. In addition, the vertical cracks are not sufficiently deep.

The present invention is provided in view of the above described problems with the prior art, and an object of the invention is to provide a scribing wheel having a long life with little wear at the blade even when used to scribe a substrate that is relatively hard, such as a ceramic substrate, which can create deep vertical cracks if necessary.

### Means for Solving Problem

The present inventors studied diligently in order to achieve the above described object, and as a result developed sintered diamond that is appropriate for application in a scribing wheel, and found that the above described object can be achieved when the outer diameter of the scribing wheel is relatively small, the grooves around the blade are deeper than those of conventional scribing wheels for glass, and the ridgeline has a certain length between grooves, and thus made the present invention. This structure allows the scribing wheel to have a long life, even when a relatively hard material, such as a ceramic substrate, is scribed. That is to say, a smaller outer diameter of the scribing wheel reduces the area of contact between the ceramic substrate and the scribing wheel, so that greater stress is generated, and deeper grooves allow the scribing wheel to create deeper vertical cracks, and a longer ridge line between grooves makes the life of the scribing wheel longer. A scribing wheel that can make vertical cracks deeper makes it possible for the load applied to the scribing wheel to be lighter, so that vertical cracks of the same depth can be created, and thus the life of the scribing wheel can be made longer. In addition, according to the present invention vertical cracks can run 60% or more of the thickness of hard, brittle materials, such as ceramic substrates, by rolling the scribing wheel over the substrate only once, and when the vertical cracks are as deep as this, the substrate can be broken (for example by hand) with a high yield.

The scribing wheel according to the present invention is a scribing wheel having a blade in V shape around the circumference of a wheel in disc form, and a number of grooves along the ridgeline of the above described blade at predetermined intervals, characterized in that the outer diameter of the above described wheel is within a range of 1 mm to 5 mm (preferably 1 mm to 3 mm), the angle of the edge of the above described blade in V shape is 90° to 160° (preferably 100° to 140°), the depth of the above described grooves is 25 μm or more, and the length of the ridge line between the above described grooves is 25 μm or more.

Here, it is preferable for the pitch of the above described number of grooves to be within a range of 50 μm to 200 μm.

It is also preferable for the ratio of the width of the above described grooves to the length of the ridgeline between the above described grooves to be 1.0 or more, in order to make the life of the scribing wheel longer.

It is preferable for the scribing wheel according to the present invention to be made of a sintered diamond body (particularly the average particle diameter of the diamond grains is 0.5 μm or less and the diamond content is 85 vol % or more).

In addition, the scribing method according to the present invention is a method for scribing a brittle material substrate, according to which a scribe line is created on the surface by rolling a scribing wheel having a blade in V shape around the circumference of a wheel in disc form, and a number of grooves along the ridgeline of the above described blade at predetermined intervals over a brittle material substrate under pressure, characterized in that the outer diameter of the above described wheel is within a range of 1 mm to 5 mm (preferably 1 mm to 3 mm), the angle of the edge of the above described blade in V shape is 90° to 160° (preferably 100° to 140°), the depth of the above described grooves is 25 μm or more, and the length of the ridge line between the above described grooves is 25 μm or more.

The method for scribing a brittle material substrate according to the present invention is appropriate for use particularly for scribing a brittle material that is harder than glass (hard, brittle material, such as ceramic, sapphire and silicon).

Furthermore, the method for cutting a ceramic substrate according to the present invention is characterized in that the above described scribing wheel may be rolled over a ceramic substrate under pressure so that a scribe line is created on the surface of the ceramic substrate and continuous cracks that run 60% or more of the thickness of the ceramic substrate are created, and after that the ceramic substrate is broken along the scribe line.

Moreover, the present invention provides use of the above described scribing wheel to create a scribe line on a ceramic substrate.

### EFFECTS OF THE INVENTION

The scribing wheel according to the present invention has an outer diameter of the wheel, a depth of the grooves and a length of the ridgeline between grooves in a predetermined range, and therefore the blade is hard to wear, and the wheel has a long life and can create deep vertical cracks if necessary and scribe a substrate that is relatively hard (hard, brittle material), such as ceramic substrates, with little wear of the blade, and create vertical cracks with a certain depth for a long period of time (long length of cut).

In the scribing method according to the present invention, the above described scribing wheel is used, and therefore a scribing wheel that can make vertical cracks deeper makes it possible for the load applied to the scribing wheel to be lighter, so that vertical cracks of the same depth can be created, and thus the life of the scribing wheel can be made longer. In addition, deep vertical cracks can be created if necessary, so that the substrate can be cut with only a scribing step. Furthermore, a hard, brittle material substrate, for example a ceramic substrate, can be cut through a scribing step and breaking step (cutting through breaking).

According to the present invention, hard, brittle materials, such as ceramic substrates, can be dry cut through breaking using a scribing wheel, and the cutting rate is almost ten times higher than in cutting using a dicing saw. Therefore, the productivity and yield of substrates that are cut out from a hard brittle material, such as ceramic, can be increased, the cost of production can be reduced, and a method for cutting a highly brittle material, such as ceramic, can be provided in an environmentally friendly manner.

According to the present invention, grooves of a predetermined depth are created around the ridge of a scribing wheel with a predetermined pitch, so that protrusions of a certain height can be formed with a predetermined pitch. When this scribing wheel is rolled over a hard, brittle material, a large stress is applied to the protrusions and continuous vertical cracks can run 60% or more of the thickness of the brittle material substrate, and the brittle material can be dry cut through breaking efficiently, with high yield and in an environmentally friendly manner by rolling the scribing wheel over the substrate only once.

### BRIEF DESCRIPTION OF THE DRAWINGS

FIG. 1 is a front diagram showing an example of the scribing wheel according to the present invention;

FIG. 2 is a side diagram showing the scribing wheel in FIG. 1;

FIGS. 3(a) to 3(c) are diagrams showing an enlargement of grooves in other examples;

FIG. 4 is a graph showing the effects of the length of the ridgeline L and the depth of the grooves D on the length of the cut;

FIG. 5 is s schematic diagram showing an example of the holder for the scribing wheel according to the present invention;

FIG. 6 is a front diagram showing the scribing unit used in accordance with the scribing method according to the present invention;

FIG. 7 is a side diagram showing the scribing unit in FIG. 6; and

FIG. 8 is a schematic diagram showing a conventional scribing wheel.

### EXPLANATION OF SYMBOLS

1 scribing wheel
2 holder
3 scribing unit
4 substrate (brittle material substrate)
5 scribing head
11 blade (outer periphery)
12 blade edge (ridge of circumference)
13 groove
14 ridgeline
D depth of grooves
W width of grooves
L length of ridgeline between grooves
P pitch of grooves

### BEST MODE FOR CARRYING OUT THE INVENTION

In the following, the scribing wheel according to the present invention is described in detail, but the present invention is not limited to these embodiments.

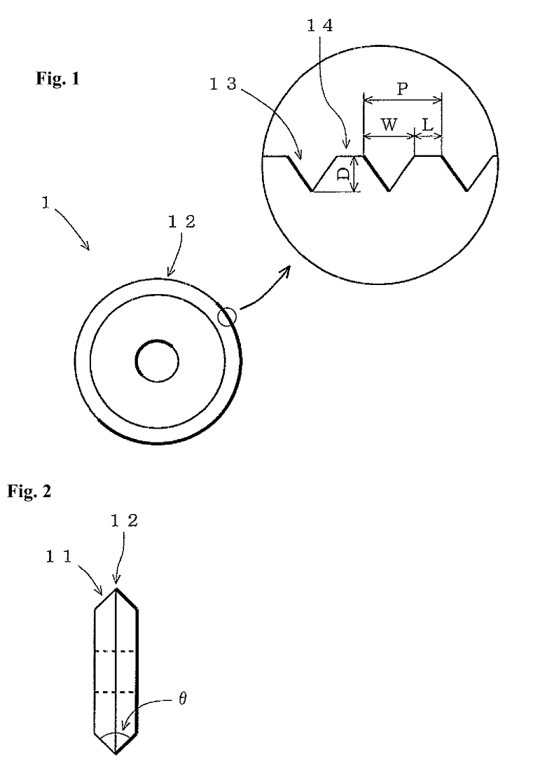

FIGS. 1 and 2 show the scribing wheel according to one embodiment of the present invention. FIG. 1 is a front diagram showing the scribing wheel as viewed in the direction of the rotational axis, and FIG. 2 is a side diagram. As shown in FIG. 2, a blade 11 in V shape is formed around the circumference of a wheel in disc form.

The angle θ of the edge of this blade 11 is usually obtuse, for example within a range of 90° to 160° (specifically, 100° to 140°), though an appropriate value can be set in accordance with the material and thickness of the substrate to be cut. As shown in FIG. 1, a number of grooves 13 in V shape are created at predetermined intervals in the edge 12 of the blade 11 along the ridgeline. Here, the number of grooves 13 in the blade edge 12 are designed in the order of micrometers, and different from the cut that is inevitably created when the blade edge is processed through cutting along the ridge line.

It is necessary for the outer diameter of the scribing wheel 1 according to the present invention to be 1 mm to 5 mm. In the case where the outer diameter of the wheel is less than 1 mm, it may not be easy to handle, and the durability may lower. In the case where the outer diameter is greater than 5 mm, the vertical cracks created through scribing may not be deep in the substrate. More preferably the outer diameter of the wheel is within a range of 1 mm to 3 mm In addition, it is preferable for the thickness of the scribing wheel to be 0.5 mm to 1.2 mm. When the scribing wheel is thinner than 0.5 mm, the processability is low, and it is not easy to handle in some cases. Conversely, when the scribing wheel is thicker than 1.2 mm, the cost of the material and manufacture may end up being high. More preferably the thickness is within a range of 0.5 mm to 1.1 mm.

It is important for the depth of the grooves 13 created in the blade edge 12 of the scribing wheel 1 to be 25 μm or more (see FIG. 1). When the depth D of the grooves 13 is 25 μm or more, the vertical cracks created in the substrate through scribing can be sufficiently deep for a long period of time (long length of cut). More preferably the depth D of the grooves is 30 μm or more. The depth D of the grooves 13 should be 60 μm or less in order to make the processability easier.

Though the grooves 13 in the scribing wheel are triangular in FIG. 1, the form of the grooves is not limited to this, and may be trapezoid (see FIG. 3(a)), U-shaped, semi-circular, (see FIG. 3(b)), or rectangular (see FIG. 3(c)). Here, the depth D of the grooves in the present invention is the distance between the ridgeline 14 and the deepest portion of the grooves 13.

It is also important for the length L of the ridgeline 14 to be 25 μm or more between the grooves (see FIG. 1). In the case where the length L of the above described ridgeline 14 is less than 25 μm, the life of the scribing wheel is short, even when the depth D of the grooves 13 is 25 μm or more. Preferably the lower limit for the length L of the ridgeline between grooves is 30 μm and the upper limit is 75 μm.

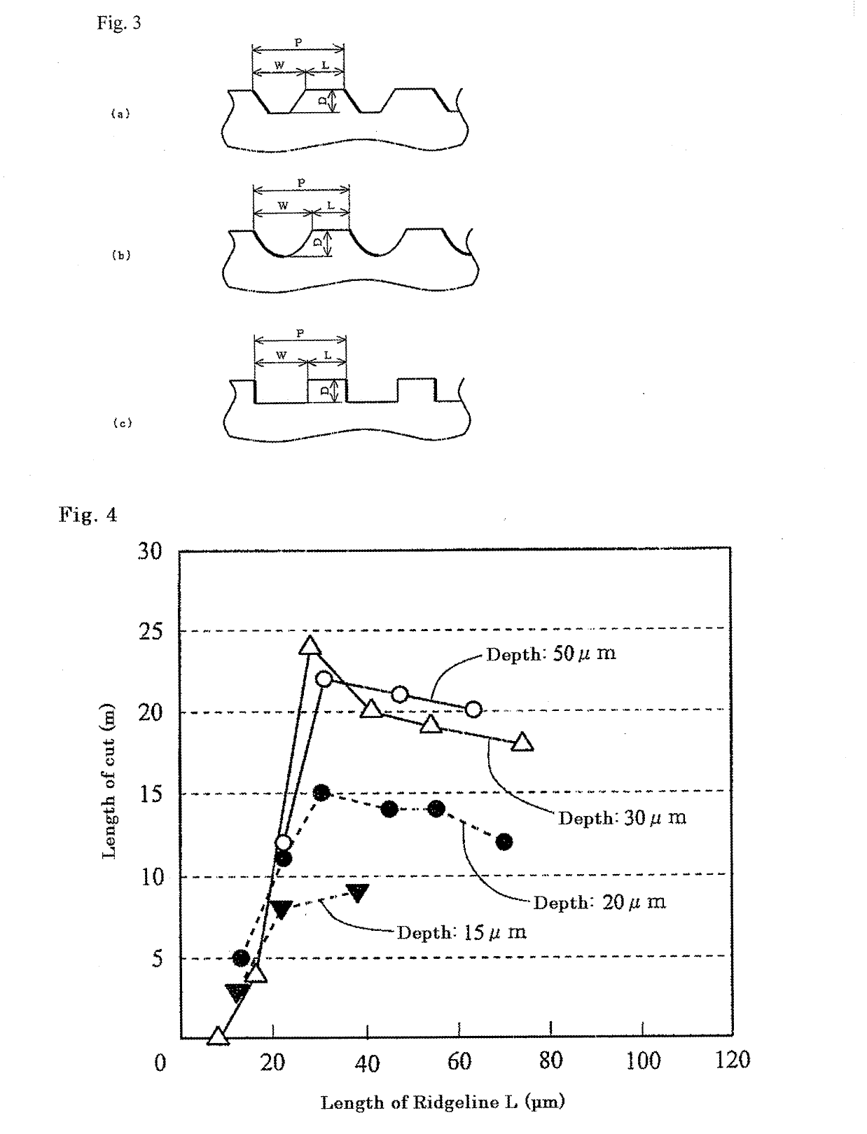

FIG. 4 shows data from experiments for checking the relationship between the depth D of the grooves 13 and the length L of the ridgeline 14 between grooves. The graph shows the relationship between the length L of the ridgeline between grooves and the length of the cut for scribing wheels for grooves D of different depths with the length of cut along the longitudinal axis and the length L of the ridgeline between grooves along the lateral axis. Here, the length of cut is the distance over which the substrate is scribed by the scribing wheel until the vertical crack becomes less than 60% of the thickness of the substrate. Accordingly, the longer the cut is, the better the scribing wheel is. The test conditions were as follows:

Substrate to be evaluated: HTCC substrate (commercially available, thickness: 0.635 mm)

Rate of scribing: 100 mm/sec

Set depth of cut: 0.15 mm

Cutting method: inner-inner cutting (cut through scribing between inside of one side of substrate and inside of other side)

Cutting direction: one-directional scribing

Form of scribing wheel: diameter: 2.0 mm, thickness: 0.65 mm, inner diameter (diameter of through hole through which pin penetrates): 0.8 mm, angle of blade edge: 110°

Pitch of grooves: 45 μm to 165 μm

Length of grooves: 25 μm to 100 μm

Length of ridgeline between grooves: 10 μm to 75 μm

Load applied to blade edge: 18 N

In the case where a length of cut of 15 m is the standard for selecting a scribing wheel, conventional scribing wheels having a depth D of the grooves of 15 μm or 20 μm do not pass, whatever the length L of the ridge line, as is clear from FIG. 4. In contrast, scribing wheels having a depth D of the grooves of 30 μm or 50 μm pass when the length L of the ridgeline between grooves is 25 μm or more.

It is preferable for the pitch P of the grooves 13 created in the blade edge 12 (see FIG. 1) to be within a range of 50 μm to 200 μm. In the case where the pitch P of the grooves 13 is less than 50 μm, the blade edge 12 of the scribing wheel 1 wears greatly, and there is a risk that the durability may lower. Meanwhile, in the case where the pitch P of the grooves 13 exceeds 200 μm, the vertical cracks are not created deep in the substrate. More preferably the pitch P of the grooves 13 is within a range of 70 μm to 170 μm.

In addition, the ratio of the width W of the grooves (see FIG. 1) to the length L of the ridgeline between grooves can be selected anywhere within a range of 0.5 to 5, but it is usually 1.0 or more, preferably 1.0 to 3.5. That is to say, it is preferable for the width W of the grooves to be the same or longer than the length L of the ridgeline between grooves. When the ratio of the width W of the grooves to the length L of the ridgeline between grooves is within this range, the cut becomes longer.

The scribing wheel according to the present invention can be fabricated in accordance with a publicly known method. A disc is cut out from a material substrate having an appropriate thickness for a scribing wheel (for example 0.5 mm to 1.2 mm), and the edge of the plate is cut around the circumference from both sides, so that the disc is thinner toward the outside in the direction of the radius, so that a blade in V shape is formed around the circumference. At this time, it is preferable for the angle of the blade edge to be within a range of 90° to 160° (more preferably 100° to 140°), as described above. In addition, grooves are created in the blade edge along the ridge line of the blade in accordance with a publicly known processing method, such as laser processing, discharge processing or cutting processing. The scribing wheel according to the present invention has a small diameter, and high precision for microscopic processing is required in order to create grooves, and therefore laser processing is recommended from among the above described processing methods. A high-frequency YAG laser or a carbon dioxide gas laser is preferably used for the laser beam generating apparatus.

It is preferable to use sintered diamond, which is a publicly known material, as the material for the scribing wheel.

It is preferable for the diamond sintered body to be formed of diamond particles and the remaining bonding phase, so that adjacent diamond particles are bonded together. When adjacent diamond particles are bonded together, the diamond sintered body has excellent resistance to wear and strength, and thus appropriate as the material for the scribing wheel according to the present invention.

Here, it is preferable for the average particle diameter of the diamond particles to be 0.5 μm or less. When the average particle diameter is small and the ratio of small diamond particles high, the life of the scribing wheel is longer.

The diamond particle content is usually 75 vol % to 90 vol % of the entirety of the diamond sintered body, but it is preferable for the diamond particle content of the diamond sintered body used in the invention to be 85 vol % or more of the total of the diamond sintered body. Here, volume percent is the ratio of the total volume of diamond particles to the total volume of the diamond sintered body, including voids. The bonding phase has a lower hardness than the diamond particles, and therefore when the diamond particle content is 85 vol % or more, the hardness can be prevented from becoming low, and when the diamond particle diameter is small the resistance against impact is high and the resistance to wear is excellent.

The bonding phase includes a bonding material and an additive. The bonding material is usually made of an element in the iron group. Examples of elements in the iron group are cobalt, nickel and iron. Cobalt is preferable from among these. It is preferable for the bonding material content in the present application to be within a range of 10 vol % to 30 vol % of the entirety of the diamond sintered body, and it is more preferable for it to be 10 vol % to 20 vol %.

An appropriate additive is a carbonate of at least one element selected from the group consisting of titanium, zirconium, vanadium, niobium and chromium.

A diamond sintered body that is appropriate for use as the material for the scribing wheel according to the present invention can be manufactured by mixing diamond particles, a bonding material and an additive and after that sintering the mixture at a high temperature under an extremely high pressure under which diamond is thermodynamically stable.

The above described mixture is sintered within the mold in an ultra high pressure generating unit, preferably for approximately 10 minutes at a temperature of 1500° C. to 1900° C. under a pressure of 5 GPa to 8 GPa.

Next, a scribing method using the above described scribing wheel is described.

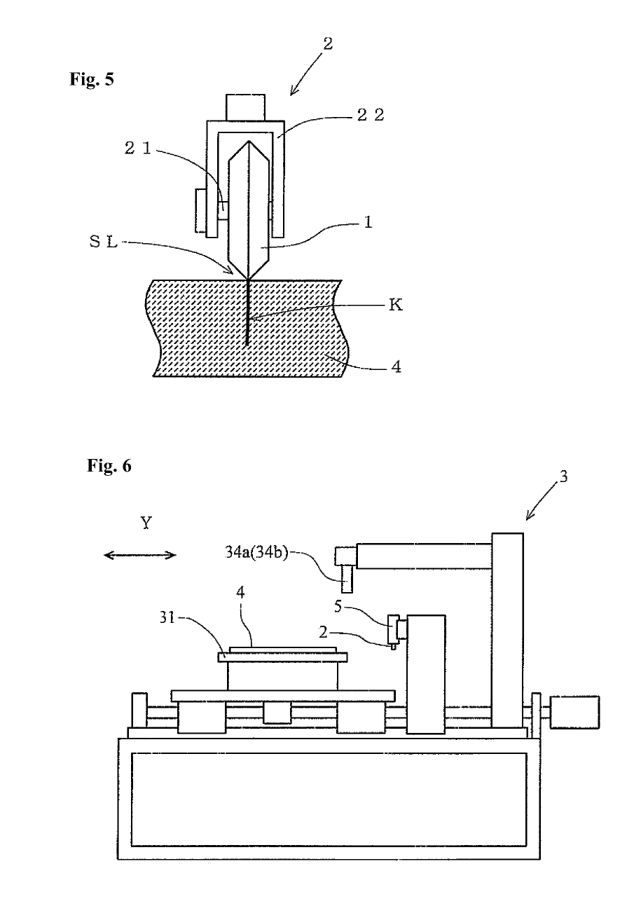

FIG. 5 is a schematic diagram showing the holder to which a scribing wheel is attached. This holder 2 supports a scribing wheel 1 by means of a pin 21, so that the scribing wheel is rotatable in the support frame 22. This holder 2 is mounted at the end of the scribe head having an elevating and pressure applying mechanism (air cylinders, a servo motor and the like) mounted in the below described scribing unit, and the elevating and pressure applying mechanism allows the scribing wheel 1 to roll over a brittle material substrate 4, for example a glass substrate, while the scribing wheel 1 is pressed against the surface of the substrate 4. As a result, a scribe line SL is created on the substrate 4, causing a vertical crack K. At this time, the load applied to the scribing wheel 1 and rate of scribing are determined in accordance with the type and thickness of the substrate 4. Usually the load applied to the scribing wheel 1 is within a range of 5 N to 50 N (preferably 15 N to 30 N), and the rate of scribing is within a range of 50 mm/sec to 300 mm/sec. Next, a breaking apparatus, not shown, is used to apply stress on the side of the substrate 4 opposite to the side on which the scribe line SL is created, so that the vertical crack K grows to the opposite side of the substrate 4, and thus the substrate is cut.

Examples of substrates that can be scribed using the scribing wheel 1 according to the present invention are brittle material substrates, such as of glass, ceramic, silicon or sapphire. The scribing wheel according to the present invention is particularly appropriate for scribing a hard, brittle material (brittle material harder than glass, such as ceramic, silicon or sapphire). Since the scribing wheel 1 according to the present invention makes it possible to create a vertical crack that is deeper than those created using conventional scribing wheels, the load applied to the scribing wheel can be lighter when vertical cracks of the same depth are created, and thus the life of the scribing wheel can be made longer. Furthermore, it becomes possible to cut hard, brittle materials, such as ceramic, silicon and sapphire, in accordance with a method having a scribing step and a breaking step. In recent years, more and more substrates used in high frequency modules relating to communication instruments are changing from HTCC (high temperature co-fired ceramic) to LTCC (low-temperature co-fired ceramic), which is easier to process, and the scribing and cutting method according to the present invention is becoming more and more effective.

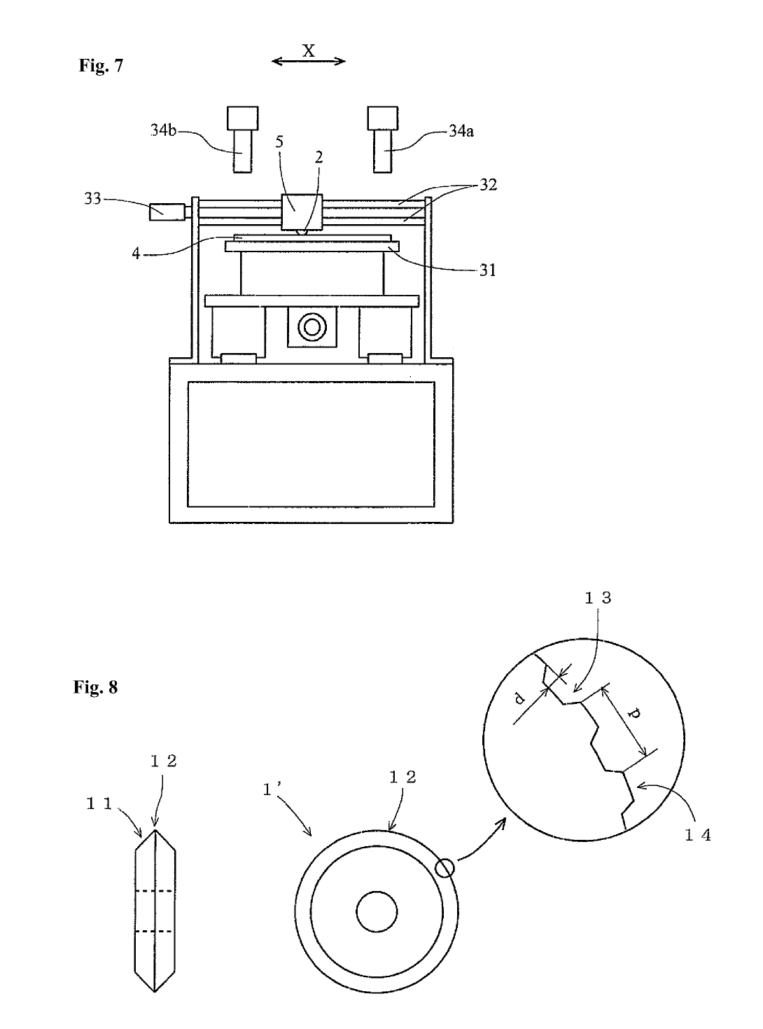

FIGS. 6 and 7 are schematic diagrams showing a scribing apparatus. FIG. 6 is a front diagram showing a scribing apparatus 3, and FIG. 7 is a side diagram. In FIG. 6, the table 31 rotates horizontally and moves in the direction Y (left and right). A substrate 4 to be processed is sucked and secured against the upper surface of the table 31 through suction by vacuum. When a pair of CCD cameras 34a and 34b recognizes an alignment mark on the substrate 4, the positional shift of the substrate 4 can be detected when the substrate 4 is positioned. In the case where the substrate 4 is shifted by an angle θ, for example, the table 31 is rotated by −θ, and in the case where the substrate 4 is shifted by +y in the direction Y (y to the right), the table 31 moves by −y in the direction Y (y to the left). Rails 32 run above the table 31 in the direction X (see FIG. 7), and a scribe head 5 reciprocates along the rails 32 by means of a cutter axis motor 33 (see FIG. 7). A holder 2 is mounted on the bottom of the scribe head 5 in such a manner as to be rotatable around the vertical axis, and the scribing wheel 1 is mounted on the holder in such a manner as to be rotatable around the horizontal pin 21 (see FIG. 5).

The scribing wheel 1 mounted on the bottom end of the holder 2 is pressed against the surface of the substrate 4 under a certain pressure (referred to as scribing load), and in this state the scribing wheel 1 is moved on the substrate 4 in an horizontal plane, so that a scribe line can be created on the top surface of the substrate 4. When the scribe head 5 moves in the direction X, a scribe line is created on the upper surface of the substrate 4 in the direction X, and this scribing operation is repeated whenever the table 31 moves in the direction Y, so that scribe lines are created one after another in the direction X. Next, the table 31 is rotated 90° by means of a drive source, not shown, and then the same scribing operation is carried out again, so that scribe lines are created in the direction perpendicular to the scribe lines created in the previous process. The scribing wheel 1 may be pressed against the surface of the substrate 4 under a certain pressure, and in this state, the table 31 may move in the direction Y, so that a scribe line can be created on the upper surface of the substrate 4 in the direction Y.

After that, a breaking apparatus applies stress on the side of the substrate opposite to the side on which scribe lines are created, so that vertical cracks grow to the opposite side of the substrate and the substrate is cut. In the case where deep vertical cracks are created in the scribing step, the substrate is cut only in the scribing step, without requiring a breaking apparatus.

### INDUSTRIAL APPLICABILITY

The scribing wheel according to the present invention can dry cut a substrate (without using a cooling or washing liquid), has a long life with little wear at the blade end, can create a deep vertical crack if necessary, and furthermore can create vertical cracks with a certain depth for a long period of time (for long length of cut) with little wear at the blade edge, even when a relatively hard, brittle material substrate, such as ceramic (for example HTCC or LTCC) silicon or sapphire, is scribed, and thus is useful.

1. A scribing wheel comprising a blade in V shape around the circumference of a wheel in disc form, and a number of grooves along the ridgeline of said blade at predetermined intervals, characterized in that
the outer diameter of said wheel is within a range of 1 mm to 5 mm,
the angle of the edge of said blade in V shape is 90° to 160°,
the depth of said grooves is 25 μm or more, and
the length of the ridge line between said grooves is 25 μm or more.

2. The scribing wheel according to claim 1, wherein the pitch of said number of grooves is within a range of 50 μm to 200 μm.

3. The scribing wheel according to claim 1, wherein the ratio of the width of said grooves to the length of the ridgeline between said grooves is 1.0 or more.

4. The scribing wheel according to claim 1, which is made of a sintered diamond body, wherein the average particle diameter of the diamond grains is 0.5 μm or less and the diamond content is 85 vol % or more.

5. A method for scribing a brittle material substrate, according to which a scribe line is created on the surface by rolling a scribing wheel comprising a blade in V shape around the circumference of a wheel in disc form, and a number of grooves along the ridgeline of said blade at predetermined intervals over a brittle material substrate under pressure, characterized in that
the outer diameter of said wheel is within a range of 1 mm to 5 mm,
the angle of the edge of said blade in V shape is 90° to 160°,
the depth of said grooves is 25 μm or more, and
the length of the ridge line between said grooves is 25 μm or more.

6. The method for scribing a brittle material substrate according to claim 5, wherein the brittle material substrate is made of at least one hard, brittle material selected from the group consisting of ceramic, sapphire and silicon.

7. A method for cutting a ceramic substrate, characterized in that the scribing wheel according to claim 1 is rolled over a ceramic substrate under pressure, so that a scribe line is created on the surface of the ceramic substrate and continuous cracks that run 60% or more of the thickness of the ceramic substrate are created, and after that the ceramic substrate is broken along the scribe line.

8. Use of the scribing wheel according to claim 1 to create a scribe line on a ceramic substrate.

9. The scribing wheel according to claim 2, wherein the ratio of the width of said grooves to the length of the ridgeline between said grooves is 1.0 or more.

10. A method for cutting a ceramic substrate, characterized in that the scribing wheel according to claim 2 is rolled over a ceramic substrate under pressure, so that a scribe line is created on the surface of the ceramic substrate and continuous cracks that run 60% or more of the thickness of the ceramic substrate are created, and after that the ceramic substrate is broken along the scribe line.

11. A method for cutting a ceramic substrate, characterized in that the scribing wheel according to claim 3 is rolled over a ceramic substrate under pressure, so that a scribe line is created on the surface of the ceramic substrate and continuous cracks that run 60% or more of the thickness of the ceramic substrate are created, and after that the ceramic substrate is broken along the scribe line.

12. A method for cutting a ceramic substrate, characterized in that the scribing wheel according to claim 4 is rolled over a ceramic substrate under pressure, so that a scribe line is created on the surface of the ceramic substrate and continuous cracks that run 60% or more of the thickness of the ceramic substrate are created, and after that the ceramic substrate is broken along the scribe line.

13. Use of the scribing wheel according to claim 2 to create a scribe line on a ceramic substrate.

14. Use of the scribing wheel according to claim 3 to create a scribe line on a ceramic substrate.

15. Use of the scribing wheel according to claim 4 to create a scribe line on a ceramic substrate.
